(19) United States
(12) Patent Application Publication
(10) Pub. No.: US 2024/0004277 A1
(43) Pub. Date: Jan. 4, 2024

(54) Ubiquitously Deployable Interactive Displays

(71) Applicant: THE REGENTS OF THE UNIVERSITY OF MICHIGAN, Ann Arbor, MI (US)

(72) Inventors: Alanson SAMPLE, Ann Arbor, MI (US); Amani ALKAYYALI, Ann Arbor, MI (US)

(73) Assignee: THE REGENTS OF THE UNIVERSITY OF MICHIGAN, Ann Arbor, MI (US)

(21) Appl. No.: 18/216,024

(22) Filed: Jun. 29, 2023

Related U.S. Application Data
(60) Provisional application No. 63/367,508, filed on Jul. 1, 2022.

(51) Int. Cl. G03B 21/20; G02B 5/23

(52) U.S. Cl. CPC G03B 21/2033; G02B 5/23

(57) ABSTRACT

Pervasive and interactive displays promise to present digital content seamlessly throughout a room. However, traditional display technologies do not scale to room-wide applications due to high per-unit-area costs and the need for constant wired power and data infrastructure. This disclosure proposes the use of photochromic paint as a display medium. Applying the paint to any surface or object creates ultra-low-cost displays, which can change color when exposed to specific wavelengths of light. New paint formulations are developed that enable wide area application of photochromic material. Along with a specially modified wide-area laser projector and depth camera that can draw custom images and create on-demand, room-wide user interfaces on photochromic enabled surfaces. System parameters such as light intensity, material activation time, and user readability are examined to optimize the display. Results show that images and user interfaces can last up to 16 minutes and can be updated indefinitely.

### FIELD

The present disclosure relates to ubiquitous deployable interactive displays.

### BACKGROUND

Pervasive and ubiquitous displays promise to extend the user interface beyond the physical boundaries of our favorite devices, and into the world around us, allowing for physically larger display surfaces and interactions with digital content. When deployed as a part of an environment's furnishings (i.e. walls, ceilings, floors, and tabletops), ubiquitous displays empower users with invaluable contextual associations with spaces and functions, while offering immediate personalization.

Many research efforts have demonstrated compelling use cases of ubiquitous displays using conventional technology in the form of large-format television screens, video projectors, and distributed displays. However, these innovative ideas have not seen widespread adoption due to the relatively high cost of the screens, cumbersome deployment methods, and need for wired power and data infrastructure. Furthermore, conventional display technologies (e.g., LCD, DLP, Plasma, OLED, etc.) are unlikely to scale to room wide deployment. Since the electronics industry is focused on developing screens with higher pixel density and better image quality, the absolute screen size of an individual unit has begun to plateau due to market forces.

To address these cost and deployability issues, one can draw inspiration from the material science community that has explored a wide range of dyes, pigments, and paints that change their physical and optical properties, such as color, based on external stimulation. For instance, thermochromic dyes were used for Hypercolor branded T-shirts, which would change color based on body heat. Likewise, there is a large variety of materials that change color based on heat, vibration, light, acidity, and chemical reactions. Additionally, when it comes to the HCl community, retrofitting large surface areas via paint has proven to be an effective means of deploying interactive systems. Therefore, considering that dyes, pigments, and paints are ubiquitously used to coat our living spaces, furniture, clothing, and devices, one can imagine a world where all surfaces can be augmented and enhanced into color-changing displays.

However, significant challenges must be overcome to take a color-changing material and turn it into a functional display. For instance, the color-changing material needs to be actuated to cause a state change. In the case of electrochromic material, which changes its color when exposed to an electric potential, a layered matrix of row and column drivers must be constructed to create a localized and controllable electric field to actuate a ‘pixel’ of electrochromic material. The need for extra elements and active layers in order to drive and digitally control the color changing material highlights an important challenge in creating low cost paintable displays, that they can be difficult to deploy. This leads to the realization that by physically disconnecting the medium, that changes its state, from the actuator, that causes the state change, it is possible to dramatically reduce the complexity of constructing ubiquitously deployable.

This section provides background information related to the present disclosure which is not necessarily prior art.

### SUMMARY

This section provides a general summary of the disclosure, and is not a comprehensive disclosure of its full scope or all of its features.

A scalable display system is presented. The system includes: a photochromatic material deposited on a display surface; a light source and a controller electrically coupled to the light source. The light source is spatially separated from the display surface and operates to project an incident beam of light onto the display surface, where the display surface faces the light source. The controller operates to turn the light source on and off, thereby rendering a display on the display surface.

A second photochromatic material may be deposited onto the display surface, where the second photochromatic material differs from the first photochromatic material.

In some embodiments, an actuator is coupled to the light source and operates to move the light source and thereby redirect the incident beam to a different location on the display surface. An optical component may also be disposed in a light path of the light source and operate to redirect the incident beam to a different location on the display surface.

In other embodiments, a second light source operates to project a second incident beam of light onto the display surface, where the second incident beam of light having a different wavelength than the incident beam of light.

The display system may further include a sensor configured to detect an interaction with the display by a person. In response to detecting an interaction, the controller issues a command to a device.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 is a diagram of an example display system.

FIG. 2 is a block diagram depicting the core components which comprise the display system.

FIGS. 3A and 3B are graphs showing absorption data from long-term Yamada DAE-0068, long-term Yamada DAE-0004, and short-term Qingdao's Garnet Red. FIG. 3A shows the wavelengths at which the different materials activate; whereas, FIG. 3B shows the wavelengths at which the long-term Yamada materials deactivate.

FIG. 4 is an illustration of a light proof box used to measure the amount of time for a material to activate and deactivate.

FIGS. 5A and 5B are graphs showing activation and deactivation times from the long-term Yamada DAE-0068, long-term Yamada DAE-0004, and short-term Qingdao Red.

FIG. 6 is a flow diagram for the control software of the display system.

FIG. 7A depicts an example user interface for the display system, where panel depicts the web interface for laser control: i) users can select from a variety of widgets to render on walls, ii) once selected, users place widgets with drag-and-drop controls, iii) users can change which wall they would like to render widgets to.

FIG. 7B depicts an example user interface for the display system, where panel depicts the web interface after a widget has been selected: i) the laser immediately begins projecting to the corresponding wall and location, ii) placed widgets appear overlaid onto an image of the wall, and can no longer be edited.

FIGS. 8A-8C illustrate an interactive display for a light switch. FIG. 8A depicts the color change on the photochromic wall; FIG. 8B depicts the pose detection with a user touching the element on the photochromic wall; and FIG. 8C depicts the interaction that occurred from touching the element on the photochromic wall.

FIGS. 9A and 9B are diagrams depicting experimental setups for a user study to determine deactivation thresholds, where i) is the participant and ii) is laser projector+depth camera in FIG. 9A and i) is the DSLR camera for recording the results and ii) is the laser projector in FIG. 9B.

FIG. 10 is a graph showing deactivation as a result of line length and activation.

Corresponding reference numerals indicate corresponding parts throughout the several views of the drawings.

### DETAILED DESCRIPTION

Example embodiments will now be described more fully with reference to the accompanying drawings.

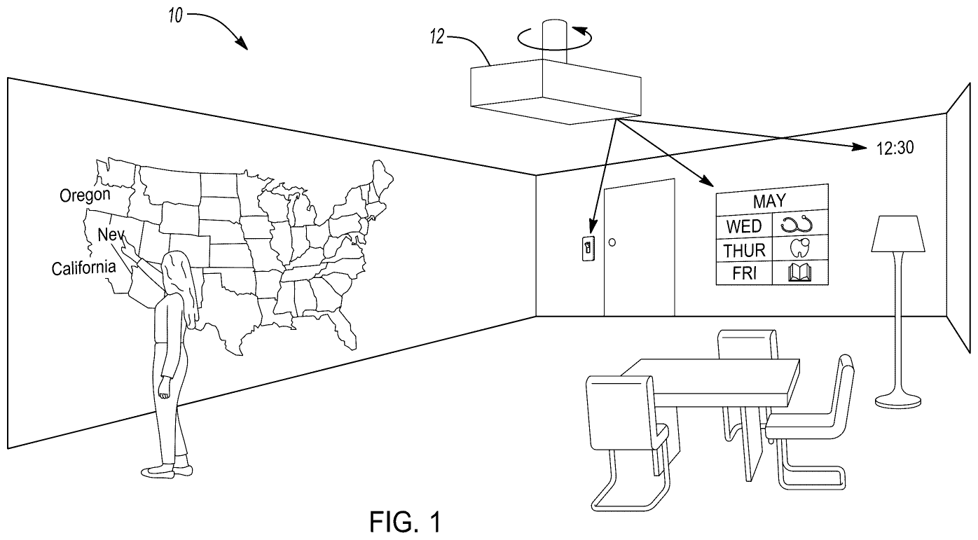

FIG. 1 depicts an example of a display system 10 in accordance with this disclosure. In this example, the walls of the room have been painted with the low cost photochromic material, and a specially designed vector laser projector 12, with a stepper motor swivel mounted to the ceiling. When the laser projector 12 shines the specific wavelength of light needed to activate the photochromic paint, semi-permanent images are drawn on the wall that last, for example between 1 and 6 minutes. Using the stepper motor, the laser projector 12 can move its effective work area to another section of wall, thereby allowing images to be deposited anywhere in the room and creating a large area display surface. The display system 10 can then display and refresh static content, such as pictures, and dynamic images, such as clocks, notifications, and calendars. In order to make the system interactive, a depth camera co-located with the laser projector is used to capture user input. The user can then define the location of interactive elements, such as light switches, music players, and environmental controls. The remainder of this disclosure introduces a display system for creating low cost ubiquitous displays that can be painted onto nearly any surface.

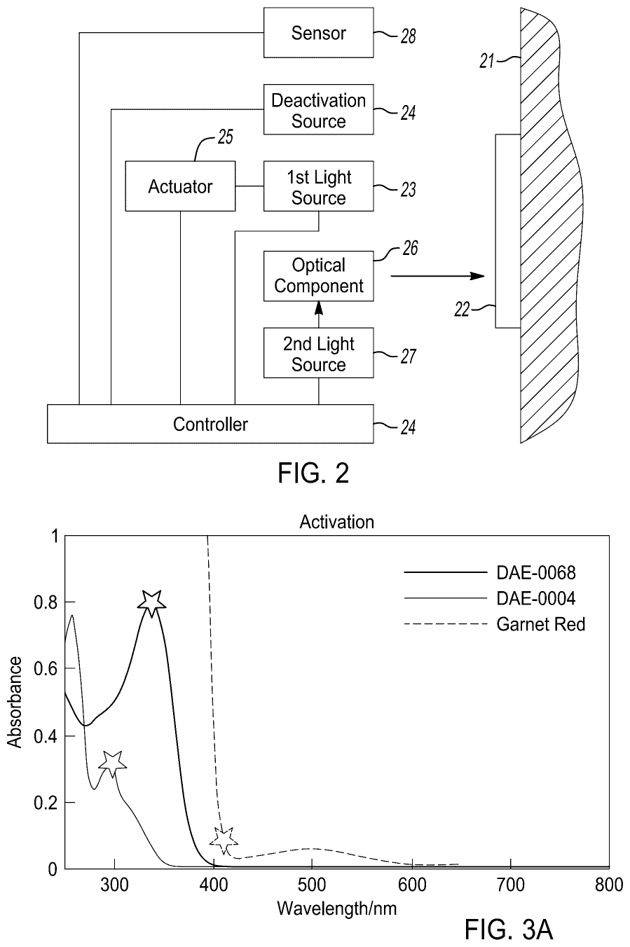

FIG. 2 further depicts the core components which comprise the display system 10. In a simplified embodiment, the display system 10 is comprised of at least one photochromatic material 22 deposited on a display surface 21; a light source 23 spatially separated from the display surface 21; and a controller 24. Although a single type of photochromatic material is used, two or more different types of photochromatic materials may be deposited onto the display surface 21. Suitable types of photochromatic materials are further described below.

During operation, the light source 23 projects a beam of light onto the display surface 21 and thereby activates the photochromatic material 22 to create a display. Once activated, the photochromatic material becomes visible for a period of time. The activation period depends upon the wavelength of the incident light and the exposure time as will be further described below. The controller 24 is electrically coupled to the light source 23 and turns the light source on and off, thereby rendering an image on the display surface. In an example embodiment, the light source is a laser although other types of light sources are contemplated by this disclosure.

Images will remain visible for an activation period which can vary, for example from a few minutes to multiple hours. To proactively deactivate an image, the system may include a deactivation light source 24 arranged proximate to the display surface 21. In an example embodiment, the deactivation light source 24 projects white light into the display surface 21. Presence of the white light on the image, deactivates the photochromatic material, such that the image is no longer visible to a person.

In a more robust embodiment, the light source 23 is coupled to an actuator 25. The actuator 25 in turn moves the light source 23 and thereby redirects the incident beam to different locations on the display surface 21. In one example, the actuator 25 is further defined as a servo motor although other types of actuators are contemplated by this disclosure. In this way, different images can be drawn (i.e., activated) onto the display surface 21. To create multiple displays, photochromatic material can be deposited onto different areas of the display surface and/or on different surfaces within the same room.

In another example, an optical component 26 is disposed in the light path of the first light source 23 or a different second light source 27. The second light source 27 may produce a second beam of light having a different wavelength than the beam of light produced by the first light source 23. In this way, the second light source 27 can be used to activate a photochromatic material different from the photochromatic material activated by the first light source 23. In either case, the optical component 26 is movable and redirects the incident beam to different locations on the display surface 21. For example, the optical component 26 is a movable mirror. Again, by redirecting the beam of light from the second light source 27, different images can be drawn (i.e., activated) on the display surface 21.

In some embodiments, the display system 10 receives input from a sensor 28 to create an interactive user element, such as a light switch. The sensor 28 is configured to detect an interaction with the display by a person. Example sensors 28 ma include but are not limited to a depth camera or a motion sensor. In response to detecting an interaction, the controller 24 can issue a command to another device. In the case of the light switch, the controller issues a command to turn on or off a light in the room. The light switch is merely illustrative of an interactive element and is not intended to be limiting.

In an exemplary embodiment, the controller 24 is implemented as a microcontroller. It should be understood that the logic for the control of display system 10 by controller 24 can be implemented in hardware logic, software logic, or a combination of hardware and software logic. In this regard, controller 24 can be or can include any of a digital signal processor (DSP), microprocessor, microcontroller, or other programmable device which are programmed with software implementing the above described methods. It should be understood that alternatively the controller is or includes other logic devices, such as a Field Programmable Gate Array (FPGA), a complex programmable logic device (CPLD), or application specific integrated circuit (ASIC). When it is stated that controller 24 performs a function or is configured to perform a function, it should be understood that controller 24 is configured to do so with appropriate logic (such as in software, logic devices, or a combination thereof).

Photochromic materials' reversible color change is due to a photochemical reaction which occurs when the material is exposed to ultraviolet or near ultraviolet light. These wavelengths change the shape of the photochromic material's chemical structure, and thus the color. The specific wavelength used for these reactions is dependent on the specific photochromic molecule. In the raw state, the photochromic material is a powder with an off-white color. When dissolved in a clear solvent, the stable-state solution remains off-white, and exhibits color after exposure to ultra-violet or near ultra-violet light. For simplicity and clarity, this disclosure refers to the white-to-color transition as “activation”, and the “color-to-white” transition as deactivation.

Photochromic materials are generally split into two categories, t-type and p-type. T-type is a photochromic material with a temporary color change, where UV light activates the material and the color changes back to white shortly after. P-type is a semi-permanent, bi-stable, material where UV light activates the material, and visible light changes the color back to white, and thus, generally lasts longer than t-type. This disclosure explores the feasibility of two t-type materials and two p-type materials, in Table 1, and refer to the t-type material as short-term photochromic material, and p-type as long-term photochromic material.

The goal is to use these color changing materials as a medium for displaying images. The challenge is to figure out different methods for creating paints, due to the differences between the short-term and long-term materials. The short-term materials activate in the purchased form, whereas the long-term materials need to be dissolved to change color.

Since the short-term materials activated out-of-the-box, they were mixed with various base materials to get them into a more paintable form. The preferred short-term binders are all water-based mediums as they are readily available off-the-shelf, do not release harmful vapors, have a shorter drying time than oil-based paints, and have a clear or white base color to avoid disrupting the activated color.

The mixed solutions were evaluated by painting swatches, taking pictures of them while fully activated, converting them to grayscale, and calculating the mean and standard deviation of the grayscale images; the closer to 0, the darker the image, and thus, the more contrast it would have. This data shows the Red Slurry combinations did not provide much contrast when activated, and that the Rust-Oleum Clear Gloss mixed with the short-term Garnet Red gave the highest contrast. The concentration that worked best with the short-term Garnet Red was the 1:6 ratio worked best; the 1:4 ratio was too thick to paint onto a surface, providing a higher standard of deviation, and the 1:8 ratio had lower contrast. The cost of the short-term Garnet Red was also lower in cost than the short-term Red Slurry, at $0.28/g compared to $0.80/g, covering 2.3 cm₂/g compared to 0.39 cm₂/g, and thus, for demonstration purposes this disclosure uses the short-term Garnet Red as the short-term material of choice.

The two long-term materials from Yamada Chemical were also tested with a number of solutions, as listed in Table 1. The materials responded similarly in solutions, and thus most of the testing was done with DAE-0004 (red) since it is lower in cost than DAE-0068 (purple-red). Neither material changed color after a solution of material dissolved in acetone or THF had dried. Nor were we successful in achieving a color change with the recipe using 3D printing materials, nor with the Sartomer CN120060 3D printing resin. However, based on Photo-Chromeleon, we experimented with DupliColor Matte Finish Clear Coat, and found that dissolving the photochromic material with Mia Secret Clear Acrylic Powder in the DupliColor paint created a viscous solution that worked best for painting.

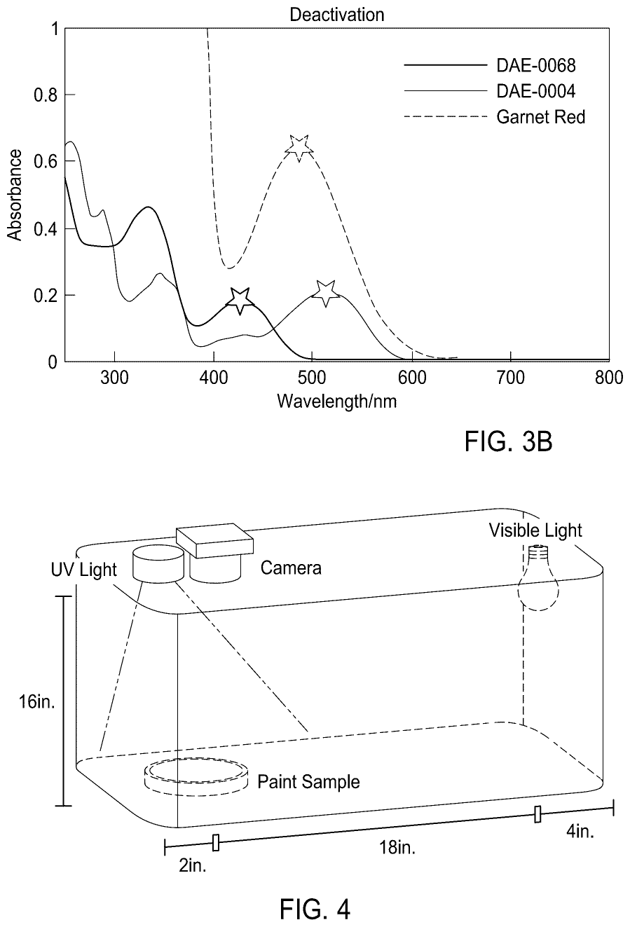

A material's absorption spectrum identifies its activation and deactivation wavelengths as shown in FIGS. 3A and 3B. Testing of photochromic materials with their binders formed insignificant, straight, horizontal lines, with no indications of an activation wavelength. Thus, the absorption spectra of materials without additives were provided by the companies.

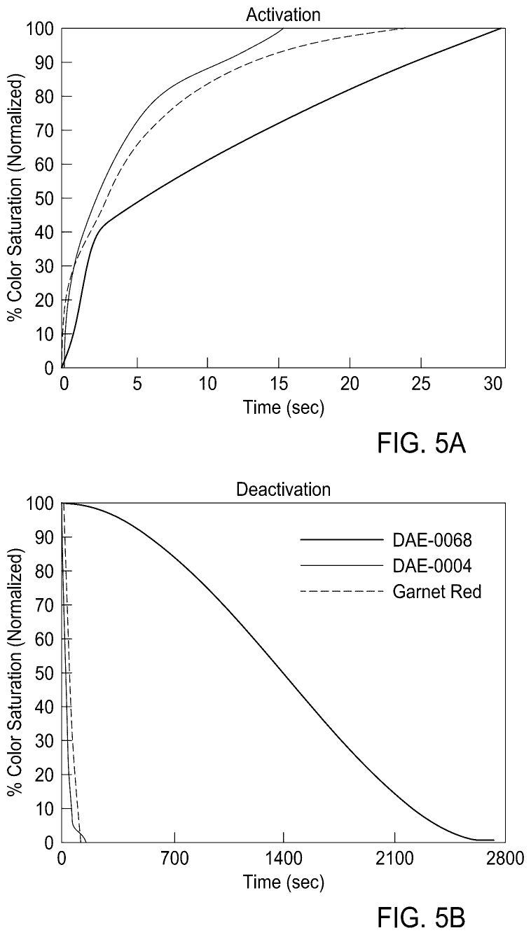

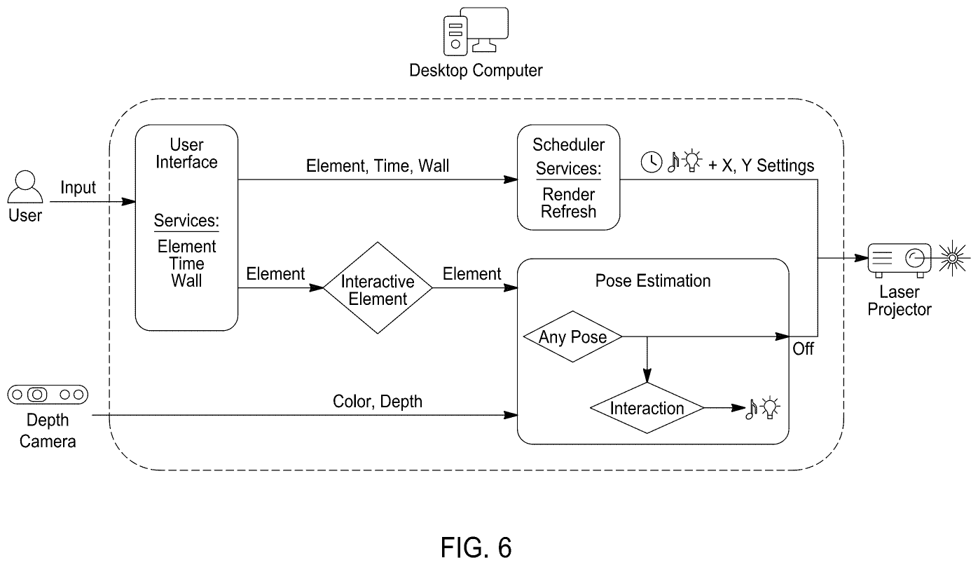

The amount of time for a material to activate and deactivate is important to building applications. Measuring these time variables requires a light proof box, equipped with a white light, a UV light, a camera, and a paint sample, as shown in FIG. 4. Each paint sample is placed in the same position, with a camera collecting images of the paint sample over time. The camera maintains constant exposure levels to ensure true color values. The UV light, 365-405 nm, activates the paint sample for three minutes with the white light off. Afterwards, the white light, at 270 lux, is on for 24 hours. Although this does not affect the short-term photochromic material, the same steps were performed for all the paint samples. The images from the camera are converted to gray-scale, averaged, and plotted, as shown in FIGS. 5A and 5B. The point at which the values begin to plateau for greater than one minute is used as the cut-off for activation or deactivation time.

From 100% activation, the short-term material lasts for approximately 16 minutes, while the long-term Yamada Red material (DAE-0004) lasts for about 20 minutes, and the long-term Yamada Purple Red (DAE-0068) material lasts for about 6 hours. However, exposing the short-term material for only 80 ms will cause it to appear for 45 seconds. The difference in time constants is important because it allows for different interaction modalities. For example, the short term material could be used for short term information such as scratch paper, whereas the long term material could be used for longer lasting information such as daily calendars.

Based on the experiments, the best recipes for creating usable short-term and long-term photochromic paints are as follows. Short-term paint requires 1 part photochromic material to 6 parts Rust-Oleum Clear Gloss by weight, stirred for 1 hour at 500 RPM. The long-term paint requires 19 g of DupliColor Matte Finish Clear Coat to 0.2 g of photochromic material to 0.8 g of Mia Secret Clear Acrylic Powder, stirring for 1 hour at 500 RPM. After the mixing, the paint can be applied can apply the paint with a foam brush or roller. The user should refrain from shining UV light while the paint drys, as it causes permanent yellowing. Wile a couple of examples are described above, these are merely illustrative of possible mixing procedures and are non-limiting.

FIG. 3A depicts the optimal wavelength to activate a particular photochromic material, however, availability and cost of the light sources should also be considered in determining which is used as an activator to change the color of the paint in the end applications. For example, the short-term material activates strongly at wavelengths below 410 nm. Fortunately, the consumer electronics industry has produced a wide number of optoelectronics with wavelengths of 405 nm. With the commercial success of Blu-ray players that use blue (or more accurately violet) lasers for reading discs, the cost of 405 nm laser diodes has fallen dramatically over the last decade and are readily available.

When choosing a light source for an application, it is important to consider how the wavelength, intensity, and the usage model can potentially impact both eye and skin safety. While UV light sources where used in the initial testing of the photochromic material, UV light sources are preferably not used as activators when building a display system. Instead, low-power, visible-light lasers are preferably used to ensure eye and skin safety. That said, laser sources present a unique challenge since the light is focused in a beam and not a defuse source. Lasers are classified based on their output power. Class 3R (or IIIa) are low powered lasers that are considered safe when handled carefully with an output power between 1 and 4.99 milliwatts. These devices rely on a person's natural aversion response to bright light, where they turns away and/or blink, limiting exposure time. Class 3R, laser pointers, with a wavelength of 405 nm, are readily available and very effective at activating the photochromic material anywhere in a room. That said, additional precautions, such as mounting the laser projector on the ceiling to limit direct exposure to a user as well as employing a depth camera to turn off the laser when a user is present, can be implemented to add as secondary level of protection.

With the photochromic material in a paintable form and the types of light sources needed to activate the paint identified, photochromic actuators that enable users to create on-demand displays, and interactive controls on nearly any surface are explored. For room scale application, a custom projector is developed with an adjoining depth camera. Video projectors and cameras have long been used in HCl to distribute images over large surfaces and capture users' hand and body position for remote collaboration, 3D reconstruction, and to create interactive white boards. However, the size of the image is still limited by the field-of-view of the projector, and objects can occlude the image from reaching the surface making interactions difficult. Since the photochromic paint can hold an image for a few minutes to several hours, it is possible to deposit an image on one section of wall, then programmatically rotate the projector with a stepper motor to deposit images throughout the rest of the room. This significantly reduces the cost per area of the display compared to traditional approaches, but has the drawback of slow update rate and being monochromatic. Secondly, transient occlusions can occur when an object blocks the light from a normal projector. This is overcome by the proposed display system, since the image resides on the surface rather than being reflected off of it.

In the example embodiment, the laser projector is a modified Laserworld DS-1000RGB vector projector that has been repurposed to include a 405 nm laser diode, and disable the other two channels. Instead of projecting a 2D image like typical consumer electronic projectors it instead uses orthogonal galvanometer mirrors to programmatically steer a 405 nm laser beam. The Laserworld projector has an Ethernet connection and communicates via the ILDA protocol (a standard by the International Laser Display Association). Pre-defined shapes and sprites, such as ASCII characters, can be uploaded to the projector via Laserworld's Showeditor software and stored on the laser's internal SD card. Using the laser to render images onto the photochromic display, one can programmatically call the shapes to create a wide variety of images at ranges of up to 3 meters (i.e., 10 feet), allowing for wide coverage area.

In the example, the laser was mounted to the ceiling. Since the laser projector is mounted to the ceiling, it must be tilted down, so that the laser point makes contact with surfaces coated in photochromic material, and in this case, angled such that it could project on two walls, a table top, and any object within that vicinity. With the laser tilted down and towards two walls, images may appear skewed. Skewing can be programmatically corrected as further described below.

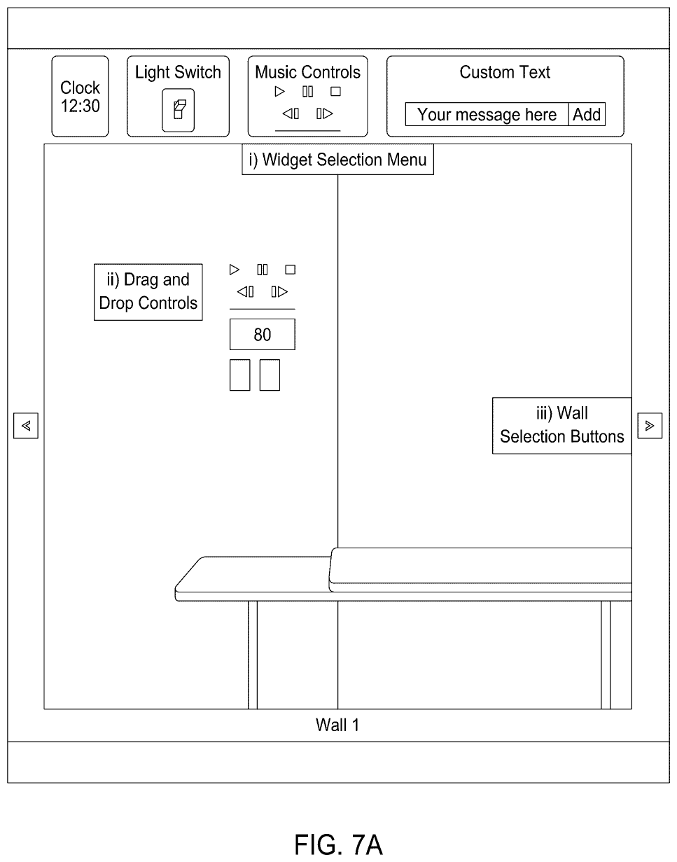

To control the laser's rendering, a set of software components were developed: (i) a web interface and backend for specifying draw requests, (ii) a scheduler to manage the laser's rendering and re-rendering of images as they fade, and (iii) a pose estimation component to determine if an interaction has occurred. The components are shown in FIG. 6 and described in more detail below.

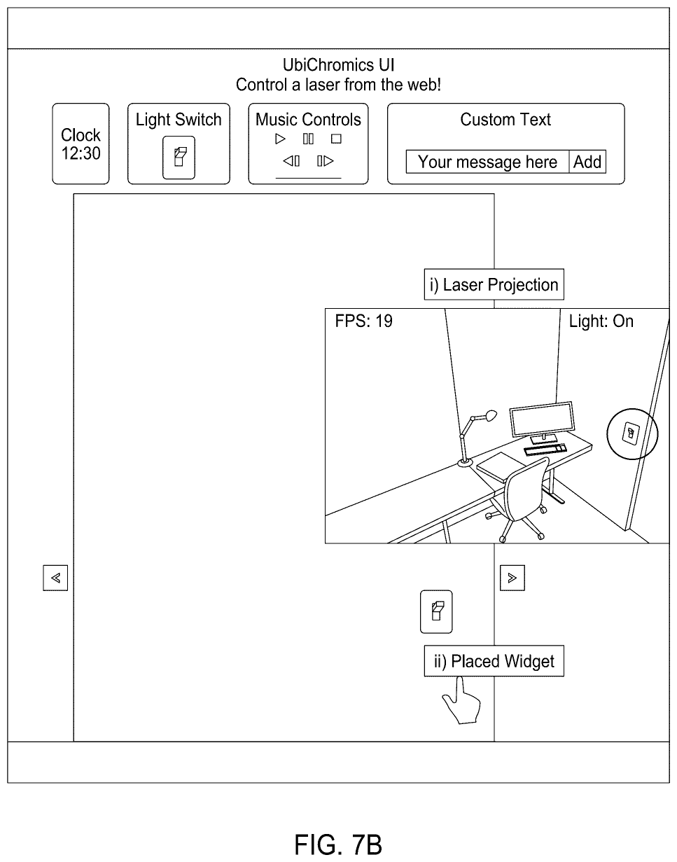

FIG. 7 shows an example of a drag-and-drop web user interface that enables end-users to control laser output, a drag-and-drop web interface. In this example, the user interface provides a variety of widgets that users can place on photochromic painted walls in their environment: a light switch, a music control panel, a clock, and a custom text input box. Once a widget is selected, it's image appears overlaid on an image of a wall to provide a preview of how the widget will look once rendered by the laser. Users can click and drag the image of the widget to adjust it's position on the wall, and optionally input a length of time that the widget should be displayed (default is 60 minutes).

Finally, users press a confirm button to send a request to the laser to draw the widget. This sends an API request containing the details of the widget placement, which calls the corresponding move and draw functions to the laser. The web interface was built using Vue.js, and Flask was used to implement the backend web server and laser request API.

The API request is processed in a Python script which handles the specific functions used to send commands to the laser, which is referred to as the scheduler. Since the color of the activated photochromic material fades over time, the scheduler refreshes and manages elements enabled by the user interface. Thus, there are two roles for the scheduler: 1) render elements selected in the user interface 2) manage the re-rendering of those elements. Meanwhile, the scheduler is also a task scheduler, to schedule elements such that projection of one element does not interrupt another projection. Rather, elements are queued until the laser finishes projecting the previous elements.

To manage elements from the user interface, the scheduler takes input from the user interface, including element (music menu, notification, light switch, etc)), x, y coordinates of the element, the time for the element to remain active, and the wall number on which the widget is to be projected. The scheduler uses this information to select which image to render from the SD card, map the interface to the laser x,y coordinates, and adjust the image size and rotation to account for skewing. Alternatively, free-form images can also be drawn directly in Python but scan time is usually slower. The scheduler also has the ability to select the images size, rotation, and scan rate. Once the element is placed, the scheduler refreshes the element every so often based on the element's deactivation time.

Thus, the scheduler refreshes each element as necessary. The scheduler continues to refresh elements until the user-specified time for each element to remain active has elapsed. For example, if a user selects the clock element, and specifies 60 minutes. The clock will update the time every minute for 60 minutes.

Indirect light has not been shown to activate the shot-term photochromic material, for example, through windows, and windows with tints or filters on them. Nor has lighting in different environments been shown to alter the deactivation time of the short-term photochromic material. Although many environments use white light, which includes 405 nm, the light diffuses such that it does not affect the painted surfaces.

In order to enable users to interact with the display, a depth camera is used to track pose and hand proximity to interactive features. In an example embodiment, the depth camera is an Intel Real sense D435i. The depth camera provides color and depth images to the computer. Using the color images and MediaPipe's BlazePose, one can track eight of the 33 key points it extracts: the wrist, pinky, thumb, and index finger for both hands. Depth data is extracted for these key points. If they are within the thresholds for the various interactive elements, perform the interaction. For example, in the case of a light switch projected on a wall, BlazePose would identify the hand, and determine if it is within the light switch threshold. The depth data then determines if the hand is in fact touching the wall/light switch. Pose estimation occurs only for the interactive elements enabled by the user interface.

In addition to using BlazePose for interactive elements, one can use BlazePose as one of many possible ways of providing users with extra comfort while using the system. When any pose features are identified, a command is immediately sent to the laser to turn it off. Once a user moves out of frame, the laser resumes rendering images. This allows users to safely interact with the projected elements, and allows the laser to re-render images when safe. While BlazePose alone is effective, BlazePose with the depth camera creates redundant safety measures. Identifying any change in the depth point cloud indicates there is movement within the area, and thus creates a secondary measure for turning the laser off. Since the user interface and scheduler know exactly where the laser will be pointing, it is possible to further create bounding boxes. Rather than looking for pose or depth in the whole frame, the program could identify pose and depth within the specific regions of interest.

To understand the feasibility of the system as a ubiquitous display, a series of experiments were performed to 1) determine the minimal color contrast for text readability on a photochromic painted wall, 2) evaluate the effect of varying the activation time of the photochromic material on the length of time images are displayed, and 3) evaluate the number of characters that can be displayed. In other words, we used these experiments to evaluate how well the 405 nm laser projector performs at actuating surfaces painted with the short-term photochromic material, and thus, to determine its effectiveness as a ubiquitous display.

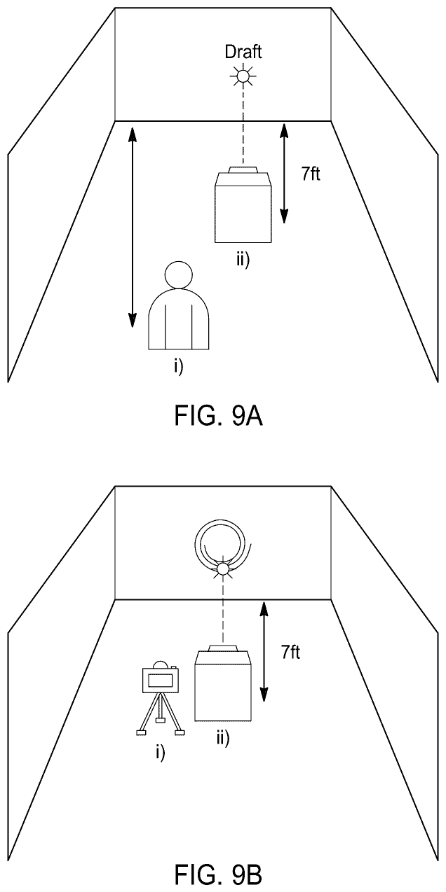

A user study was conducted to determine the minimum acceptable color contrast for text readability between the original wall color and activated red paint color. Ten participants were recruited, ages (22+/−3 years), nine men and one woman. Participants were asked to keep glasses or contact lenses on if they wore them on a regular basis. The laser was placed seven feet away from the wall for this task, and participants stood nine feet away from the wall displaying the reading content, as shown in FIG. 9A. Each session was video recorded and took, on average, 20 minutes to complete.

Participants were asked to read a random series of 15 5-letter words and express their confidence level for reading the word on a 1 to 5 Likert scale (where 1 is not confident and 5 is very confident). One word was displayed at a time, for 15 increasing lengths of time, from one second, up to 80 seconds. Words were allowed to fade completely from the wall in between reading exercises.

Participants were asked to verbally announce any and all letters they could visualize, and it was observed that participants could begin to identify letters correctly at 10% color activation, and as indicated by a 5 on the Likert scale, could correctly and confidently identify whole words at 30% color activation.

All of the participants were able to correctly identify 100% of the words at and after 25 seconds of activation. From these results, 30% color contrast was used as the deactivation threshold for the laser projector evaluation described below, use this to determine the point at which the laser should refresh text and images on the wall so that they are constantly perceivable.

In order to determine the laser/wall system's efficacy for being a ubiquitous display, the laser was evaluated to gauge how many characters it could project on the wall. To make this evaluation more universal, one can look at characters as a factor of line length. This way, one could consider images, such as the shape of a Mona Lisa line drawing, or more traditional characters, such as letters and numbers.

For the evaluation, the laser projector was placed seven feet away from a wall, as shown in FIG. 9B and projected spirals of varying lengths, from 22 inches to 233 inches, for 5, 10, 25, and 50 seconds. A video recording was captured, holding lighting and exposure constant, of the wall as the color faded to determine the initial level of color contrast, and how long the image stays on the wall. The color contrast is defined from 0% (wall color) to 100% (fully activated), and the results of the user study were used as the basis for the point at which the image was considered faded. In between each experiment, the images faded completely.

As expected, the smallest image, that with the shortest line length, coupled with the highest activation time, achieved the highest contrast, at 100%, which is the darkest the paint can possibly get when activated. Also as expected, the largest image, that with the longest line length, coupled with the shortest activation time, achieved the lowest contrast, at 0%, which is the base wall color, indicating no color change occurred.

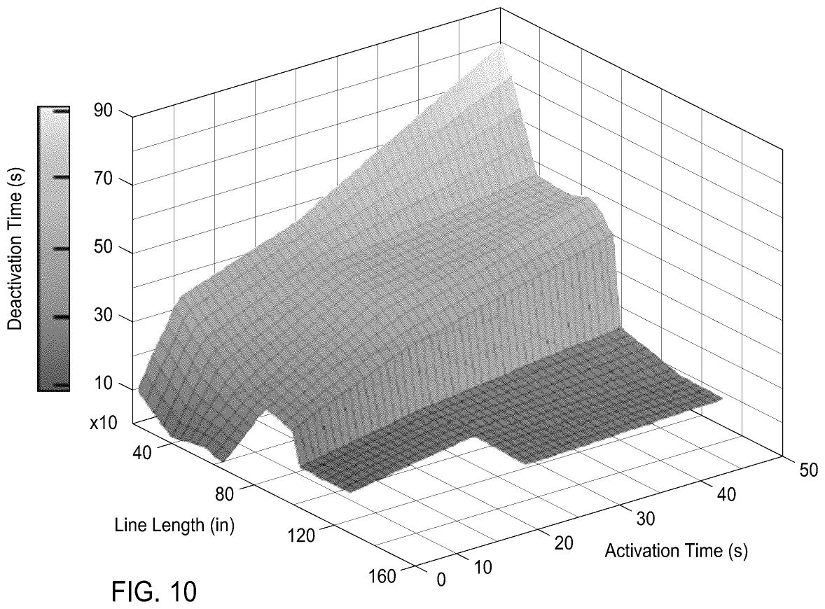

The values in between 0% and 100% color contrast are represented in FIG. 10. With this information, one can predict how many characters the laser can project. The minimal color contrast used to count a character and consider it visible is 30%, based on the user study. With this information, Equation 1 was developed using three variables: deactivation time, line length, and activation time. In the experiments, line length and activation were altered to see the change in deactivation times. Thus, to predict deactivation, the equation is setup to solve for D, deactivation time, using variables L and A, line length, and activation time. This allows users to quickly select the best parameters for the system they are developing. The coefficients for these factors were determined by MATLAB's linear regression function. As line length increases, and activation time remains constant, deactivation decreases. As activation time increases, and line length remains constant, deactivation increases.

DeactivationTime=154−1.86*Length+12.9*ActivationTime−0.0715*Length*ActivationTime (1)

Thus, one can tell if the laser can handle refreshing a clock, music menu, and light switch, or just a clock and light switch. Of course, this is a limitation with the laser, and not the paint or using it for ubiquitous displays. To achieve more characters, one could add more lasers or implement other actuators.

The display system described above can be used in a number of ways to create practical, ubiquitous displays. For example, the display system can be used to create static images, such as notifications, messages and art, dynamic displays, like a clock, and interactive elements, like a music menu and light switch.

As shown in FIG. 7, to carry out any of these applications, a user would begin by selecting the element of interest from the web interface, and dragging and dropping it to a location on the wall of choice. The user may then select how long they would like the element to remain active. The time to remain active refers to the time in which the laser would re-render the image to keep it from fading. In the background, the interface and backend pass the element, x,y coordinates of the element, wall number, and time to remain active to the Python scheduler, and pass just the element to the Python pose script. The scheduler then projects the element in the specified location, while the pose script awaits interactions for interactive elements, such as the music menu and light switch. Below is a further description of each of the elements and how they represent the usability of photochromic ubiquitous displays.

For example, there are a number of notifications individuals check on a daily basis including social media, emails, phone calls, and calendar events. Many of these require the user's short-term attention. Thus, notifications lend themselves to be displayed on photochromic paint with a short deactivation time. If the notification needs to last longer, the user can enable the laser projector to re-render the images to keep them from fading. With the laser programmed via Python, one can customize messages or show alerts for various programs that display messaging notifications, phone calls, or calendar events.

Similar to notifications, people enjoy having custom art work displayed, and like to change it on a regular basis. Photochromic-coated walls allow users to do that without the need to repaint their walls, hang new wallpaper, or mount new artwork. In fact, users could use other deep-blue light sources to interact with and add to wall art.

For dynamic elements, photochromic paint is continually reconfigurable, and the quick deactivation time lends itself well to creating continuously refreshed elements, such as a wall clock, which needs to update every minute. A digitally reconfigurable clock on a photochromic-coated wall allows a user to quickly place the clock anywhere without mounting, creating nail holes, or pulling a phone out of a pocket while busy with another task. The same benefits apply to creating similar elements, like custom countdown timers when cooking.

As homes become smarter, devices, such as smart thermostats, retrofit traditional analog dials with touch screens. However, this still restricts the interaction space to statically-located physical manifestations (i.e., your thermostat remains in the same place on your wall indefinitely). For this reason, the use of photochromic surfaces and laser projectors give way to intelligent materials, and further enable smart environments. Augmenting the environment with intelligent materials such as photochromic surfaces, provides users with the ability to control their surroundings, from anywhere in their home, without having to install various devices. This also allows users to use one surface for many widgets, and changing the widgets as their preferences change.

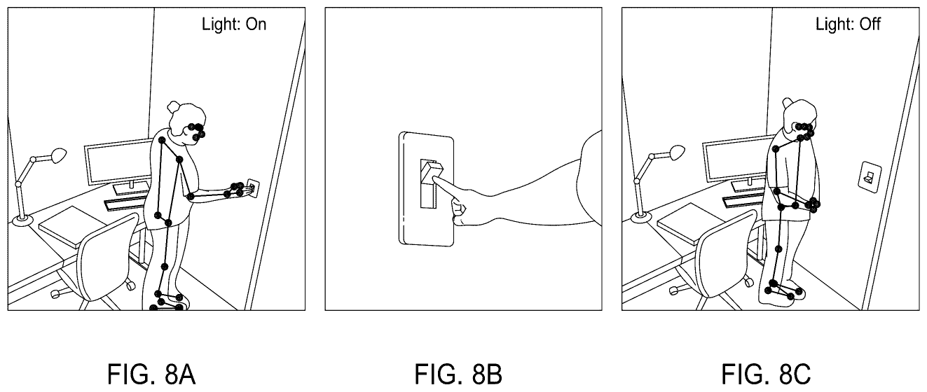

Pairing the system with a depth camera allows us to use hand tracking for interactions. One such application is the light switch, as shown in FIG. 8. Similar interactions are envisioned with other stationary widgets, like thermostats, where a projected circle can behave as a dial, increasing or decreasing the room temperature.

Screen sizes have been growing across all form factors, including smartphones and tablets, to enable easier viewing and greater immersion. However, the size of these devices is restricted by cost and portability. The proposed display system achieves the large-scale interaction, at low costs, by taking advantage of large existing surfaces, such as walls and tables. With a simple coat of paint, the system makes way for expanding menus such as a music menu. Similar interactions are envisioned for productivity applications (e.g., word processor, calculator), where users often access special symbols and algebraic operations that are found only in menus. These elements also double as social widgets that can be used by multiple people, creating a photochromic jukebox or collaborative writing environment.

Image contrast can be an issue under certain situations, such as short activation durations or low intensity light sources. Low contrast decreases visibility of the activated area and thus the legibility of the display, making interaction more difficult. However, to improve contrast, users can increase the contrast by increasing the power of the light source or the activation duration. For reference, one can render high-contrast points with a blue 5 mW laser pointer at an activation time of 200 ms.

Actuators beyond the laser can also be explored, as depicted by our preliminary work on a smart pen and smartphone case. These photochromic actuators open up a whole new world of use cases for mobile interactions. These devices enable a wider variety of applications due to their close-proximity to photochromic surfaces, and thus, are safer for use with ultra-violet light sources and long-term photochromic material. Replicating pen and paper, an LED pen can enable the user to make on-demand interfaces by writing text or drawing images on a photochromic surface and then tapping on the drawn object to activate a service, without requiring extensive instrumentation of the environment. Making use of the processing power, smartphones can be paired with various sensors, to detect interactions and phone movement, as well as control arrays of ultraviolet LEDs, which work on both short-term and long-term paints, to deposit images, as well as interactive elements like buttons, sliders, and knobs, offering the possibility of extending the phone's display beyond the confines of the screen.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A scalable display system, comprising:
a photochromatic material deposited on a display surface;
a light source spatially separated from the display surface and operable to project an incident beam of light onto the display surface, where the display surface faces the light source; and
a controller electrically coupled to the light source and operates to turn the light source on and off, thereby rendering a display on the display surface.

2. The display system of claim 1 wherein the light source is a laser.

3. The display system of claim 1 further comprises a second photochromatic material deposited on the display surface, where the second photochromatic material differs from the first photochromatic material.

4. The display system of claim 1 further comprises an actuator coupled to the light source and operable to move the light source and thereby redirect the incident beam to a different location on the display surface.

5. The display system of claim 1 further comprises an optical component disposed in a light path of the light source and operable to redirect the incident beam to a different location on the display surface.

6. The display system of claim 1 further comprises a second light source operable to project a second incident beam of light onto the display surface, where the second incident beam of light having a different wavelength than the incident beam of light.

7. The display system of claim 1 further comprises a sensor configured to detect an interaction with the display by a person, wherein the controller, in response to detecting an interaction, issues a command to a device.

8. The display system of claim 1 further comprises a deactivation light source arranged proximate to the display surface and operates to project white light onto the display surface.

9. A scalable display system, comprising:
a photochromatic material deposited on a display surface;
an activation light source spatially separated from the display surface and operable to project an incident beam of light onto the display surface, where the display surface faces the light source;
a deactivation light source arranged proximate to the display surface and operates to project white light onto the display surface; and
a controller electrically coupled to the light source and operates to turn the light source on and off, thereby rendering a display on the display surface.

10. The display system of claim 9 wherein the activation light source is a laser.

11. The display system of claim 9 further comprises a second photochromatic material deposited on the display surface, where the second photochromatic material differs from the first photochromatic material.

12. The display system of claim 9 further comprises an actuator coupled to the activation light source and operable to move the activation light source and thereby redirect the incident beam to a different location on the display surface.

13. The display system of claim 9 further comprises an optical component disposed in a light path of the activation light source and operable to redirect the incident beam to a different location on the display surface.

14. The display system of claim 9 further comprises a second light source operable to project a second incident beam of light onto the display surface, where the second incident beam of light having a different wavelength than the incident beam of light.

15. The display system of claim 9 further comprises a sensor configured to detect an interaction with the display by a person, wherein the controller, in response to detecting an interaction, issues a command to a device.

16. A scalable display system, comprising:
a photochromatic material deposited on a display surface;
a light source spatially separated from the display surface and operable to project an incident beam of light onto the display surface, where the display surface faces the light source;
a controller electrically coupled to the light source and operates to turn the light source on and off, thereby rendering a display on the display surface; and
a sensor configured to detect an interaction with the display by a person, wherein the controller, in response to detecting an interaction, issues a command to a device.

17. The display system of claim 16 further comprises a second photochromatic material deposited on the display surface, where the second photochromatic material differs from the first photochromatic material.

18. The display system of claim 16 further comprises an actuator coupled to the light source and operable to move the light source and thereby redirect the incident beam to a different location on the display surface.

19. The display system of claim 16 further comprises an optical component disposed in a light path of the light source and operable to redirect the incident beam to a different location on the display surface.

20. The display system of claim 16 further comprises a second light source operable to project a second incident beam of light onto the display surface, where the second incident beam of light having a different wavelength than the incident beam of light.
